(19) United States
(12) Patent Application Publication
(10) Pub. No.: US 2014/0010052 A1
(43) Pub. Date: Jan. 9, 2014

(54) CAPACITIVE TRANSDUCER

(71) Applicant: CANON KABUSHIKI KAISHA, Tokyo (JP)

(72) Inventors: Kazutoshi Torashima, Yokohama-shi (JP); Takahiro Akiyama, Kawasaki-shi (JP)

(21) Appl. No.: 13/926,532

(22) Filed: Jun. 25, 2013

(30) Foreign Application Priority Data
Jul. 6, 2012 (JP) 2012-151940

(51) Int. Cl. B06B 1/02

(52) U.S. Cl. CPC B06B 1/0292
USPC 367/181; 29/594

(57) ABSTRACT

Provided is a capacitive transducer having a wide frequency band width and an improved transmitting and receiving sensitivity, the capacitive transducer including an element including a plurality of cells: each of the plurality of cells including: a first electrode; a vibrating film including a second electrode, the second electrode being opposed to the first electrode with a gap; and a supporting portion that supports the vibrating film, in which the element includes a first cell and a second cell as the cell, the first cell including the vibrating film having a first spring constant, the second cell including the vibrating film having a second spring constant smaller than the first spring constant; and a distance between the first electrode and the second electrode of the first cell is smaller than a distance between the first electrode and the second electrode of the second cell.

### BACKGROUND OF THE INVENTION

1. Field of the Invention

The present invention relates to a capacitive transducer to be used as an ultrasonic transducer element or the like, and a method of manufacturing the capacitive transducer.

2. Description of the Related Art

Hitherto, micromechanical members to be manufactured using micromachining technology may be processed on the order of micrometers, and various functional microelements are realized using such micromechanical members. A capacitive transducer using such technology is being researched as an alternative to a transducer using a piezoelectric element. With such a capacitive transducer, an acoustic wave, such as an ultrasonic wave, a sonic wave, and a photoacoustic wave (hereinafter sometimes represented by ultrasonic wave), may be transmitted and received using vibrations of a vibrating film, and in particular, excellent broadband characteristics (characteristics with a relatively high receiving sensitivity or transmitting sensitivity in a wide frequency domain) in a liquid may be obtained with ease.

As the above-mentioned technology, a capacitive transducer that realizes broadband characteristics has been proposed, which includes a cell including a vibrating film having a high spring constant and a cell including a vibrating film having a low spring constant (see U.S. Pat. No. 5,870,351). Another capacitive transducer that realizes broadband characteristics has been proposed, which has a cell group of multiple cells having a high spring constant and a cell group of multiple cells having a low spring constant (see U.S. Patent Application Publication No. 2007/0059858).

The capacitive transducers as described above are capable of transmission and reception driving by applying a common voltage to a common electrode of the cell including the vibrating film having a high spring constant and the cell including the vibrating film having a low spring constant. In this case, however, the electromechanical transformer ratio differs among multiple kinds of cells, that is, the cell including the vibrating film having a high spring constant and the cell including the vibrating film having a low spring constant. Therefore, although broadband characteristics are realized, the transmitting sensitivity representing the ratio of a transmitted sound pressure to a pulse voltage or the receiving sensitivity representing the ratio of a received electric signal to a received sound pressure may be lowered because the electromechanical transformer ratio differs among the multiple kinds of cells.

### SUMMARY OF THE INVENTION

In view of the above-mentioned problem, according to an exemplary embodiment of the present invention, there is provided a capacitive transducer, including an element including a plurality of cells: each of the plurality of cells including: a first electrode; a vibrating film including a second electrode, the second electrode being opposed to the first electrode with a gap; and a supporting portion that supports the vibrating film so as to form the gap. The element includes a first cell and a second cell as the cell, the first cell including the vibrating film having a first spring constant, the second cell including the vibrating film having a second spring constant smaller than the first spring constant. A distance between the first electrode and the second electrode of the first cell is smaller than a distance between the first electrode and the second electrode of the second cell.

Further features of the present invention will become apparent from the following description of exemplary embodiments with reference to the attached drawings.

### BRIEF DESCRIPTION OF THE DRAWINGS

FIGS. 1A and 1B are diagrams illustrating a capacitive transducer according to an embodiment and Example 1 of the present invention.

FIGS. 2A and 2B are diagrams illustrating a capacitive transducer according to another embodiment and Example 2 of the present invention.

FIG. 3 is a diagram illustrating a capacitive transducer according to another embodiment and Example 3 of the present invention.

FIGS. 4A, 4B, 4C, and 4D are diagrams illustrating an exemplary method of manufacturing the capacitive transducer according to the present invention.

FIG. 5 is a diagram illustrating an exemplary device for acquiring test object information by using the capacitive transducer according to the present invention.

### DESCRIPTION OF THE EMBODIMENTS

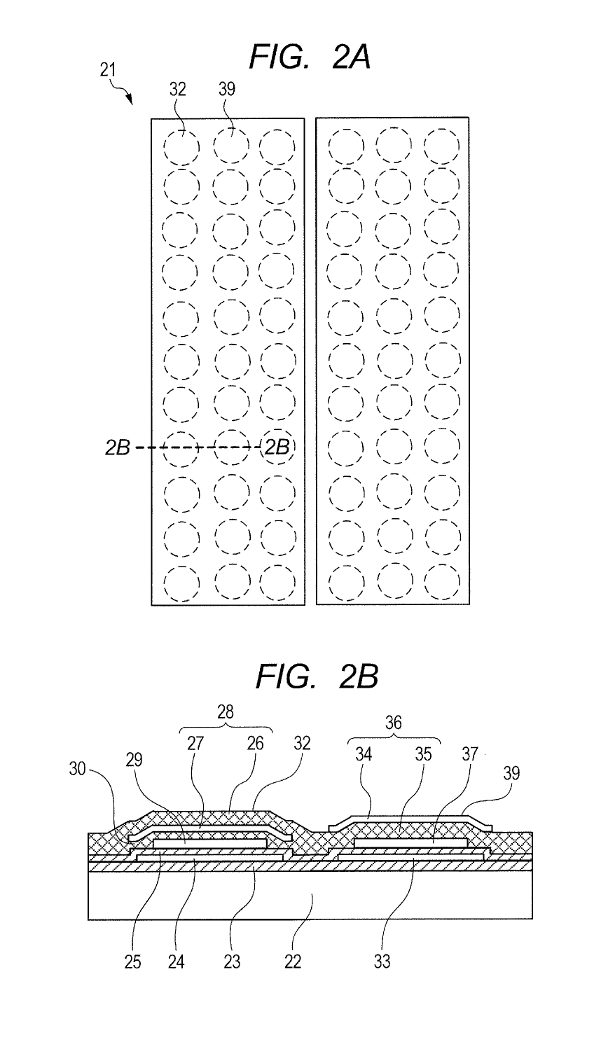

The feature of a capacitive transducer according to the present invention is to provide multiple kinds (two kinds or at least three kinds) of cells having different spring constants of vibrating films and different inter-electrode distances in order to realize broadband characteristics. This structural feature enables the multiple kinds of cells to be designed to have various structures under certain restrictions. For example, the thickness of a vibrating film of a first cell having a large spring constant is set to be larger than the thickness of a vibrating film of a second cell having a small spring constant, and the area of the vibrating film of the first cell is set to be substantially equal to the area of the vibrating film of the second cell. In this manner, the cells are allowed to have substantially the same radiation impedance. This example is illustrated in FIGS. 2A and 2B to be referred to later. The radiation impedance as used herein refers to the ratio between the vibration speed of the vibrating film and a force (pressure) acting on the outside (air, liquid medium, or the like) from the vibrating film, and depends on the shape of the cell and the shape of the vibrating film. Alternatively, the area of the vibrating film of the first cell having a large spring constant may be set to be smaller than the area of the vibrating film of the second cell having a small spring constant, and the thickness of the vibrating film of the first cell may be set to be substantially equal to the thickness of the vibrating film of the second cell. This structure is manufactured more easily.

The structure of the present invention can realize broadband characteristics, but, when a common voltage is applied from a common electrode, the electromechanical transformer ratio of the first cell may become lower than the electromechanical transformer ratio of the second cell, and hence the transmitting or receiving sensitivity may be lowered. The electromechanical transformer ratio becomes higher as the ratio of an applied voltage to a pull-in voltage becomes higher. The pull-in voltage as used herein refers to an applied voltage between a first electrode and a second electrode at which the electrostatic attractive force becomes larger than a restoring force of the vibrating film so that the vibrating film is brought into contact with a lower surface of a gap. When applied with a voltage equal to or higher than the pull-in voltage, the vibrating film is brought into contact with the lower surface of the gap. In the case where the applied voltage is set so as not to exceed the pull-in voltage, the electromechanical transformer ratio is proportional to the product of the capacitance between the first electrode and the second electrode and the electric field intensity. The electric field intensity is proportional to the applied voltage, and hence the electromechanical transformer ratio is proportional to the product of the capacitance between the first electrode and the second electrode and the applied voltage, and becomes maximum when the pull-in voltage is applied. The pull-in voltage is proportional to about 0.5 power of the spring constant and to about 1.5 power of an effective gap between upper and lower electrodes. The effective gap as used herein refers to the sum of a cavity gap and a value obtained by dividing the thickness of the vibrating film formed between upper and lower electrodes by the relative permittivity. The pull-in voltage becomes higher as the spring constant of the vibrating film becomes higher and as the distance between the first electrode and the second electrode becomes larger. Therefore, under substantially the same other structural conditions, the pull-in voltage of the cell having a high spring constant of the vibrating film is higher than the pull-in voltage of the cell having a low spring constant of the vibrating film. According to the structure of the present invention, the spring constants of the vibrating films and the inter-electrode distances are adjusted so as to reduce or eliminate the difference between the pull-in voltage of the first cell and the pull-in voltage of the second cell. Accordingly, even when the common voltage is applied, the electromechanical transformer ratios can be improved. Thus, according to the capacitive transducer of the present invention, the receiving frequency band width or the transmitting frequency band width can be increased, and the transmitting sensitivity or the receiving sensitivity can be improved.

Alternatively, the capacitive transducer may further include a first voltage applying unit for applying a voltage between the electrodes of the first cell and a second voltage applying unit for applying a voltage between the electrodes of the second cell. In this case, even when the pull-in voltage of the first cell and the pull-in voltage of the second cell are different from each other, the transmitting sensitivity or the receiving sensitivity can be improved by appropriately adjusting the magnitudes of the respective voltages to be applied to the multiple kinds of cells. As described above, according to the capacitive transducer of the present invention, the receiving or transmitting frequency band width can be increased, and, by appropriately designing the spring constants of the vibrating films and the inter-electrode distances, the transmitting sensitivity or the receiving sensitivity can be improved as well.

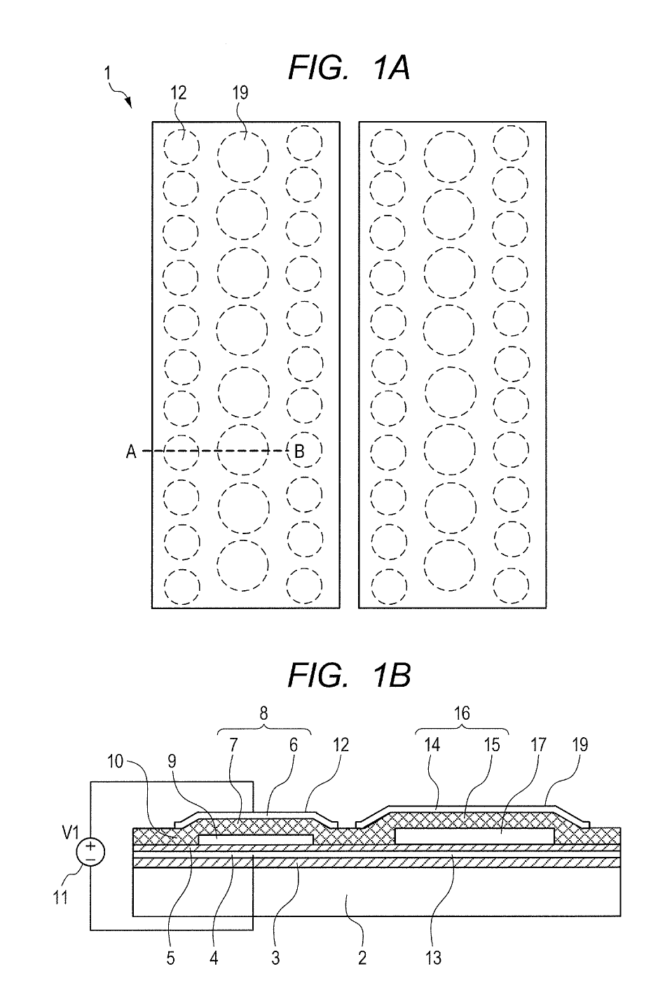

Referring to the accompanying drawings, an embodiment of the present invention is described below. FIG. 1A is a top view of a capacitive transducer according to this embodiment, and FIG. 1B is a cross-sectional view taken along the line A-B of FIG. 1A. This embodiment exemplifies multiple capacitive transducers (elements) 1 each including multiple first cells 12 and multiple second cells 19. FIGS. 1A and 1B illustrate only two capacitive transducers, but the number of the transducers is not limited thereto. The multiple capacitive transducers each include twenty-two first cells 12 and eight second cells 19, but the numbers of the respective cells are not limited thereto. The cells can be arranged in various ways.

The first cell 12 in this embodiment includes a substrate 2, an insulating film 3 formed on the substrate 2, a first electrode 4 formed on the insulating film 3, and an insulating film 5 formed on the first electrode 4. The first cell 12 further includes a vibrating film 8, a supporting portion 10 that supports the vibrating film 8, and a cavity (gap) 9. The vibrating film 8 includes a second electrode 6 and a membrane 7. In the case where the substrate 2 is an insulating substrate such as a glass substrate, the insulating film 3 may not be formed.

The second cell 19 has substantially the same structure as that of the first cell 12. In the second cell 19, a vibrating film 16 has a spring constant lower than that of the vibrating film 8 of the first cell 12. In FIG. 1B, the vibrating film 16 is made of the same material and has the same thickness as the vibrating film 8. The diameter of the vibrating film 16 is set to be larger than the diameter of the vibrating film 8, thereby decreasing the spring constant. The shape of the vibrating film is circular, but may be square, rectangular, or the like.

The capacitive transducer further includes a voltage applying unit 11 for applying a voltage between a first electrode and a second electrode of each of the first cell 12 and the second cell 19. The second cell 19 includes a first electrode 13, a second electrode 14, a membrane 15, and a cavity (gap) 17.

The membranes 7 and 15 of the vibrating films 8 and 16 are insulating films. In particular, it is desired that the membranes 7 and 15 be formed of a silicon nitride film because the silicon nitride film can be formed with a small tensile stress of, for example, 300 MPa or less so that the vibrating films can be prevented from being greatly deformed by a residual stress of the silicon nitride film. The membranes 7 and 15 of the vibrating films 8 and 16 are not necessarily insulating films. For example, monocrystalline silicon having a low resistivity of 1 Ωcm or less may be used for the membranes 7 and 15. In this case, the membrane may be used also as the second electrode.

As described above, the spring constant of the vibrating film 16 of the second cell 19 is lower than the spring constant of the vibrating film 8 of the first cell 12. Therefore, the receiving frequency band width or the transmitting frequency band width can be increased.

In this embodiment, the spring constant of the vibrating film 16 of the second cell 19 is lower than the spring constant of the vibrating film 8 of the first cell 12, and the pull-in voltage of the cell having a high spring constant of the vibrating film is higher than the pull-in voltage of the cell having a low spring constant of the vibrating film. In this case, when a common voltage is simply applied to the common electrode, the electromechanical transformer ratio of the first cell becomes lower than the electromechanical transformer ratio of the second cell, and hence the transmitting or receiving sensitivity is lowered. According to the structure of the present invention, the distance between the first electrode 4 and the second electrode 6 of the first cell is set to be smaller than the distance between the first electrode 13 and the second electrode 14 of the second cell so as to increase the pull-in voltage of the second cell relatively. In this manner, the pull-in voltages of the first and second cells are made close to each other as a whole. In the case where the insulating film or the like has relative permittivity (the ratio relative to its relative permittivity in vacuum), the distance between the first electrode and the second electrode is calculated by adding together the thickness of the insulating film, the height of the gap, and the thickness of the membrane, with the thickness of the insulating film being an effective thickness obtained by dividing the thickness by the relative permittivity.

The method of forming the structure of the present invention is not particularly limited. Examples of the method include a method of setting the thickness of the membrane 15 of the second cell to be larger than the thickness of the membrane 7 of the first cell and forming the second electrode on the membrane, a method of setting the height of the cavity 17 of the second cell to be larger than the height of the cavity 9 of the first cell, and a method of setting the thickness of the insulating film 5 of the second cell to be larger than the thickness of the insulating film 5 of the first cell.

This structure can reduce or eliminate the difference between the pull-in voltage of the first cell and the pull-in voltage of the second cell, and therefore improve the transmitting sensitivity or the receiving sensitivity. Thus, according to the capacitive transducer of this embodiment, the receiving frequency band width or the transmitting frequency band width can be increased, and the transmitting sensitivity or the receiving sensitivity can be improved.

Alternatively, the thickness of the vibrating film of the first cell may be set to be larger than the thickness of the vibrating film of the second cell, and the area of the vibrating film of the first cell may be set to be equal to the area of the vibrating film of the second cell. According to this structure, the cells have the same shape when viewed from above as illustrated in FIG. 2A, and hence the radiation impedances are matched among all the cells. Therefore, the cells have the same radiation impedance, and hence the vibrating films of the cells are vibrated in the same manner, which can prevent an undesired vibration responsible for lowering the transmitting or receiving sensitivity. Alternatively, the area of the vibrating film of the first cell may be set to be smaller than the area of the vibrating film of the second cell, and the thickness of the vibrating film of the first cell may be set to be equal to the thickness of the vibrating film of the second cell. In the case where the thickness of the vibrating film of the first cell is not equal to the thickness of the vibrating film of the second cell, for example, in the case where one of the vibrating films is etched after the film formation or the vibrating films are formed at different thicknesses, the ratio between the spring constant of the vibrating film of the first cell and the spring constant of the vibrating film of the second cell is liable to fluctuate. If the ratio between the spring constant of the vibrating film of the first cell and the spring constant of the vibrating film of the second cell fluctuates, the transmitting or receiving sensitivity of the capacitive transducer fluctuates, and the frequency band width is not always set to a desired band. Therefore, this structure having the same vibrating film thickness can reduce the fluctuations in transmitting or receiving sensitivity and frequency band width.

The capacitive transducer may have the structure in which a first voltage applying unit for applying a voltage between the first electrode and the second electrode of the first cell and a second voltage applying unit for applying a voltage between the first electrode and the second electrode of the second cell are provided. This structure enables different voltages to be applied to the first cell and the second cell, and therefore improve the transmitting sensitivity or the receiving sensitivity more.

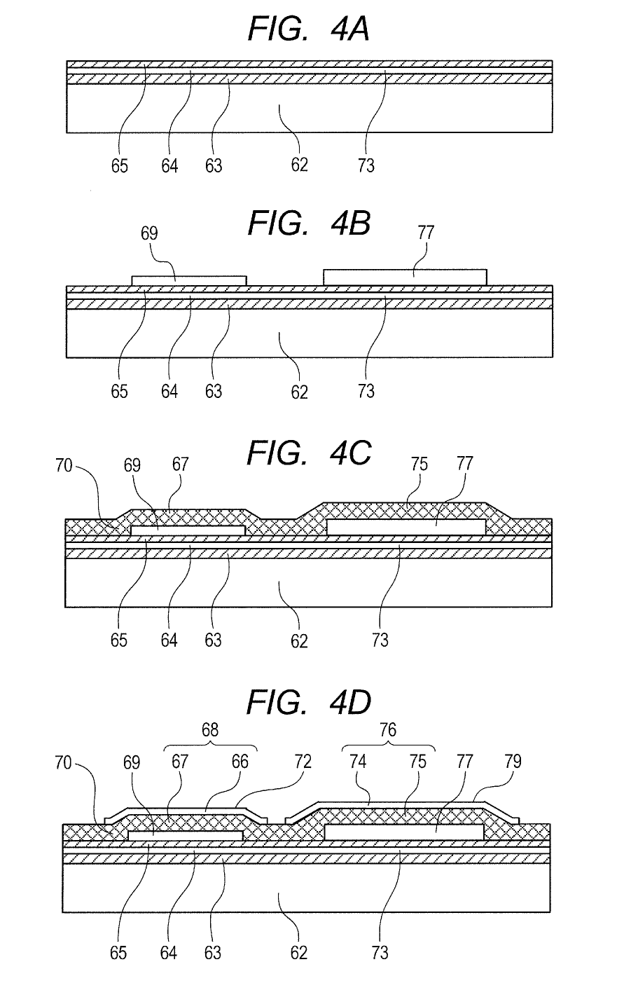

Referring to FIGS. 4A to 4D, an exemplary manufacturing method according to the present invention is described below. FIGS. 4A to 4D are cross-sectional views of the capacitive transducer, illustrating substantially the same structure as that of FIGS. 1A and 1B. FIGS. 4A to 4D correspond to the cross-sectional views taken along the line A-B of FIG. 1A. As illustrated in FIG. 4A, an insulating film 63 is formed on a substrate 62. The substrate 62 is a silicon substrate. The insulating film is a layer for insulating the substrate 62 from the first electrode. In the case where the substrate 62 is an insulating substrate such as a glass substrate, the insulating film 63 is not always required to be formed. It is desired that the substrate 62 have a small surface roughness. If the surface roughness is large, the surface roughness is transferred even in a film forming step following this step, and the distance between the first electrode and the second electrode fluctuates among cells because of the surface roughness. The fluctuations in distance are responsible for the fluctuations in electromechanical transformer ratio and the fluctuations in sensitivity and band. It is therefore desired that the substrate 62 have a small surface roughness.

First electrodes 64 and 73 are subsequently formed. It is desired that the first electrodes 64 and 73 be made of a conductive material having a small surface roughness. Examples of the material include titanium and aluminum. If the surface roughness of the first electrode is large, the distance between the first electrode and the second electrode fluctuates among cells and elements because of the surface roughness. Thus, similarly to the substrate, a conductive material having a small surface roughness is desired.

Next, an insulating film 65 is formed. It is desired that the insulating film 65 be made of an insulating material having a small surface roughness. The insulating film 65 is formed in order to prevent an electrical short circuit or a dielectric breakdown between the first electrode and the second electrode when a voltage is applied between the first electrode and the second electrode. In the case where the capacitive transducer is driven with a low voltage, the insulating film 65 is not always required to be formed because the membrane serves as an insulator. Another purpose of forming the insulating film 65 is to prevent the first electrode from being etched when a sacrificial layer is removed in a step following this formation step. The insulating film 65 is not always required to be formed in the case where the first electrode is not etched depending on the type of an etchant and an etching gas used when the sacrificial layer is removed. If the surface roughness of the insulating film 65 is large, the distance between the first electrode and the second electrode fluctuates among cells because of the surface roughness. Thus, similarly to the substrate, an insulating film having a small surface roughness is desired. The insulating film 65 is, for example, a silicon nitride film or a silicon oxide film.

Next, as illustrated in FIG. 4B, sacrificial layers 69 and 77 are formed. The sacrificial layer 69 is formed so as to have a smaller height than that of the sacrificial layer 77. This structure enables the height of the cavity of the first cell to be lower than the height of the cavity of the second cell. It is desired that the sacrificial layers 69 and 77 be made of a material having a small surface roughness. If the surface roughness of the sacrificial layer is large, the distance between the first electrode and the second electrode fluctuates among cells because of the surface roughness. Thus, similarly to the substrate, a sacrificial layer having a small surface roughness is desired. It is also desired that the material have a high etching rate in order to shorten an etching time period of etching for removing the sacrificial layer. The sacrificial layer is required to be made of such a material that the insulating film and the membrane are hardly etched by an etchant or an etching gas for removing the sacrificial layer. If the insulating film and the membrane are etched by an etchant or an etching gas for removing the sacrificial layer, the thickness of the vibrating films and the distance between the first electrode and the second electrode fluctuate. The fluctuations in thickness of the vibrating films and the fluctuations in distance between the first electrode and the second electrode are responsible for the fluctuations in sensitivity and band among cells. In the case where the insulating film and the membrane are silicon nitride films or silicon oxide films, the sacrificial layer is desired to be made of such a material having a small surface roughness and to be etched by an etchant or an etching gas that hardly etches the insulating film and the membrane. Examples of the materials include amorphous silicon, polyimide, and chromium. In particular, a chromium etchant is desired in the case where the insulating film and the membrane are silicon nitride films or silicon oxide films, because the chromium etchant hardly etches the silicon nitride films or the silicon oxide films.

Next, as illustrated in FIG. 4C, membranes 67 and 75 are formed. It is desired that the membranes 67 and 75 have a low tensile stress of, for example, 300 MPa or less. The stress of a silicon nitride film can be controlled, and a low tensile stress of 300 MPa or less can be obtained. In the case where the membrane has a compressive stress, the membrane causes sticking or buckling to be greatly deformed. In the case where the membrane has a large tensile stress, the membrane may be broken. It is therefore desired that the membranes 67 and 75 have a low tensile stress. The membranes 67 and 75 are made of, for example, a silicon nitride film whose stress can be controlled to obtain a low tensile stress. A supporting portion 70 for the vibrating film is further provided.

Further, etching holes (not shown) are formed, and the sacrificial layers 69 and 77 are removed via the etching holes, followed by sealing the etching holes. For example, the etching holes can be sealed with a silicon nitride film or a silicon oxide film. The sacrificial layer removal step or the sealing step may be performed after the formation of second electrodes to be described later. In other words, in the step of FIG. 4C following the step of forming the sacrificial layers to different thicknesses, at least a part of the vibrating films of the multiple kinds of cells may be formed on the sacrificial layers.

Next, as illustrated in FIG. 4D, second electrodes 66 and 74 are formed. It is desired that the second electrodes 66 and 74 be made of a material having a small residual stress. Examples of the material include aluminum. In the case where the sacrificial layer removal step or the sealing step is performed after the formation of the second electrodes, it is desired that the second electrodes be made of a material that is resistant to etching of the sacrificial layers and is heat resistant. Examples of the material include titanium. In this manner, the capacitive transducer is manufactured, which includes the first cell 72 that has the vibrating film 68 including the membrane 67 and the second electrode 66 and the second cell 79 that has the vibrating film 76 including the membrane 75 and the second electrode 74.

The manufacturing method described above can manufacture a capacitive transducer having a wide receiving frequency band width or transmitting frequency band width and an improved transmitting sensitivity or receiving sensitivity.

Now, the present invention is described in detail below by way of more specific examples.

### Example 1

Example 1 of the present invention is now described with reference to FIGS. 1A and 1B. FIG. 1A is a top view of the capacitive transducer of the present invention, and FIG. 1B is a cross-sectional view taken along the line A-B of FIG. 1A.

Example 1 exemplifies multiple capacitive transducers 1 each including multiple first cells 12 and multiple second cells 19. FIGS. 1A and 1B illustrate only two capacitive transducers, but the number of the transducers is not limited thereto. The multiple capacitive transducers each include twenty-two first cells and eight second cells 19, but the numbers of the respective cells are not limited thereto. The cells can be arranged in various ways. As illustrated in FIG. 1A, the shape of the vibrating film of Example 1 is circular, but may be square, hexagonal, or the like

The first cell 12 includes a silicon substrate 2 having a thickness of 300 μm, an insulating film 3 formed on the silicon substrate 2, a first electrode 4 formed on the insulating film 3, and an insulating film 5 formed on the first electrode 4. The first cell 12 further includes a vibrating film 8, a supporting portion 10 that supports the vibrating film 8, and a cavity 9. The vibrating film 8 includes a second electrode 6 and a membrane 7. The cavity has a height of 100 nm. The first cell 12 further includes a voltage applying unit 11 for applying a voltage between the first electrode and the second electrode.

The insulating film 3 is a silicon oxide film having a thickness of 1 μm formed by thermal oxidation. The insulating film 5 is a silicon oxide film having a thickness of 100 nm formed by plasma-enhanced chemical vapor deposition (PE-CVD). The first electrode is made of titanium and has a thickness of 50 nm. The second electrode 6 is made of aluminum and has a thickness of 100 nm. The membrane 7 is a silicon nitride film manufactured by PE-CVD, which is formed with a tensile stress of 200 MPa or less and has a thickness of 1,400 nm.

According to the capacitive transducer of Example 1, an electric signal can be extracted from the second electrode 6 with the use of lead-out wiring (not shown). In the case of receiving an ultrasonic wave by the capacitive transducer, a DC voltage is applied to the first electrode 4 in advance. When the ultrasonic wave is received, the vibrating film 8 including the second electrode 6 is deformed to change the height of the cavity 9 between the second electrode 6 and the first electrode 4, with the result that the capacitance is changed. The change in capacitance causes a current to flow through the above-mentioned lead-out wiring. This current is converted into a voltage by a current-voltage transducer (not shown). In this manner, an ultrasonic wave can be received. On the other hand, by applying a DC voltage to the first electrode and applying an AC voltage to the second electrode, the vibrating film 8 can be vibrated by electrostatic force. In this manner, an ultrasonic wave can be transmitted.

The second cell 19 has substantially the same structure as that of the first cell 12. Although the vibrating film 8 of the first cell 12 has a diameter of 32 μm, a vibrating film 16 of the second cell 19 has a diameter of 44 μm. Thus, the vibrating film 16, which includes a second electrode 14 opposed to a first electrode 13, and a membrane 15, has a spring constant lower than that of the vibrating film 8 of the first cell 12. Although the cavity 9 of the first cell 12 has a height of 100 nm, a cavity 17 of the second cell 19 has a height of 200 nm.

In FIG. 1B, the vibrating film 16 is made of the same material and has the same thickness as the vibrating film 8. The diameter of the vibrating film 16 is set to be larger than that of the vibrating film 8, thereby decreasing the spring constant. The spring constant of the first cell is 92 kN/m, and the spring constant of the second cell is 55 kN/m. The spring constant as used herein refers to a value determined by dividing a load on the vibrating film by an average displacement of the vibrating film caused by the load. The capacitive transducer of Example 1 includes the first cell including the vibrating film having a high spring constant and the second cell including the vibrating film having a low spring constant, and hence the receiving frequency band width or the transmitting frequency band width can be increased.

In Example 1, the vibrating film 16 is made of the same material and has the same thickness as the vibrating film 8, and hence the vibrating films of the first cell and the second cell can be formed in the same step. Therefore, the fluctuations in the ratio between the spring constant of the vibrating film of the first cell and the spring constant of the vibrating film of the second cell can be reduced, and hence the fluctuations in transmitting or receiving sensitivity and frequency band width can be reduced.

According to this structure, the spring constant of the vibrating film 16 of the second cell 19 is lower than the spring constant of the vibrating film 8 of the first cell 12, and the height of the cavity 17 of the second cell 19 is set to be larger than the height of the cavity 9 of the first cell 12. In the case where the cavity of the second cell 19 has the same height of 100 nm as that of the first cell 12, the pull-in voltage of the second cell 19 is 200 V and the pull-in voltage of the first cell 12 is 100 V. In the structure of the present invention, however, the pull-in voltages of the first and second cells 12 and 19 can be set to 200 V.

In the capacitive transducer according to Example 1, a voltage of 180 V is applied to each of the first electrode of the first cell having a high spring constant of the vibrating film and the first electrode of the second cell having a low spring constant of the vibrating film. In other words, the applied voltages are 90% of the pull-in voltages of the first cell 12 and the second cell 19. According to this structure, the pull-in voltages of the first cell and the second cell are equal to each other, and hence the applied voltages have substantially the same ratio to the pull-in voltages. Thus, the electromechanical transformer ratios of the first cell and the second cell are not deteriorated.

Thus, according to the capacitive transducer of the present invention, the receiving frequency band width or the transmitting frequency band width can be increased, and the transmitting sensitivity or the receiving sensitivity can be improved.

### Example 2

The structure of a capacitive transducer according to Example 2 of the present invention is described with reference to FIGS. 2A and 2B. FIG. 2A is a top view of the capacitive transducer according to Example 2 of the present invention, and FIG. 2B is a cross-sectional view taken along the line 2B-2B of FIG. 2A. The structure of the capacitive transducer according to Example 2 is substantially the same as in Example 1.

In Example 2, the vibrating film thickness of a cell having a higher spring constant of the vibrating film is larger than the vibrating film thickness of another cell having a lower spring constant of the vibrating film, and the vibrating film area of the cell having a higher spring constant of the vibrating film is equal to the vibrating film area of the another cell having a lower spring constant of the vibrating film. A vibrating film 28 of a first cell 32 and a vibrating film 36 of a second cell 39 both have a diameter of 32 μm. The vibrating film 28 has a thickness of 1,400 nm, and the vibrating film 36 has a thickness of 1,150 nm. According to this structure, the first cell has a spring constant of 92 kN/m, and the second cell has a spring constant of 55 kN/m.

Therefore, the capacitive transducer according to Example 2 includes the first cell that includes the vibrating film having a high spring constant and the second cell that includes the vibrating film having a low spring constant, and hence the receiving frequency band width or the transmitting frequency band width can be increased. A gap 29 of the first cell 32 and a gap 37 of the second cell 39 have the same height of 200 nm. A second electrode 27 of the first cell 32 is formed at a position 700 nm away from the cavity-side lower surface of the vibrating film 28, and a second electrode 34 of the second cell 39 is formed at a position 1,150 nm away from the cavity-side lower surface of the vibrating film 36.

This structure is manufactured as follows. A sacrificial layer, which is to be shaped into a cavity by etching, is formed. After that, a silicon nitride film to serve as a membrane is formed to have a thickness of 700 nm, and the second electrode 27 of the first cell 32 is formed. After that, another silicon nitride film is formed to have a thickness of 450 nm, and the second electrode 34 of the second cell 39 is formed. Subsequently, the silicon nitride films are formed and etched so that the vibrating film 28 of the first cell 32 may have a thickness of 1,400 nm and the vibrating film 36 of the second cell 39 may have a thickness of 1,150 nm. The second electrode 34 made of titanium is formed on the surface of the vibrating film 36 of the second cell 39, and hence the second electrode 34 of the second cell 39 functions as an etching stop layer. Thus, the fluctuations in frequency caused by the fluctuations in thickness of the vibrating film 36 of the second cell 39 can be reduced.

In this structure, the spring constant of the vibrating film 36 of the second cell 39, which includes the second electrode 34 and the membrane 35, is lower than the spring constant of the vibrating film 28 of the first cell 32, which includes the second electrode 27 and the membrane 26. On the other hand, the second electrode 27 of the first cell 32 is formed at a position 700 nm away from the cavity-side lower surface of the vibrating film 28, and the second electrode 34 of the second cell 39 is formed at a position 1,150 nm away from the cavity-side lower surface of the vibrating film 36. According to this structure, the pull-in voltage of the first cell 12 can be set to 200 V, and the pull-in voltage of the second cell 19 can be set to 200 V. Note that, in FIGS. 2A and 2B, a capacitive transducer 21 includes a substrate 22, an insulating film 23, a first electrode 24 of the first cell 32, an insulating film 25, a vibrating film supporting portion 30, and a first electrode 33 of the second cell 39.

In the capacitive transducer according to Example 2, a voltage of 180 V is applied to each of the first electrode of the first cell having a high spring constant of the vibrating film and the first electrode of the second cell having a low spring constant of the vibrating film. In other words, the applied voltage is 90% of the pull-in voltages of the first cell 32 and the second cell 39. According to this structure, the pull-in voltages of the first cell and the second cell are equal to each other, and hence the applied voltages have substantially the same ratio to the pull-in voltages. Thus, the electromechanical transformer ratios of the first cell and the second cell are not deteriorated.

Therefore, in the capacitive transducer according to Example 2, the receiving frequency band width or the transmitting frequency band width can be increased, and the transmitting sensitivity or the receiving sensitivity can be improved. Besides, according to this structure, the cells have the same shape when viewed from above as illustrated in FIG. 2A, and hence the radiation impedances are matched among all the cells.

### Example 3

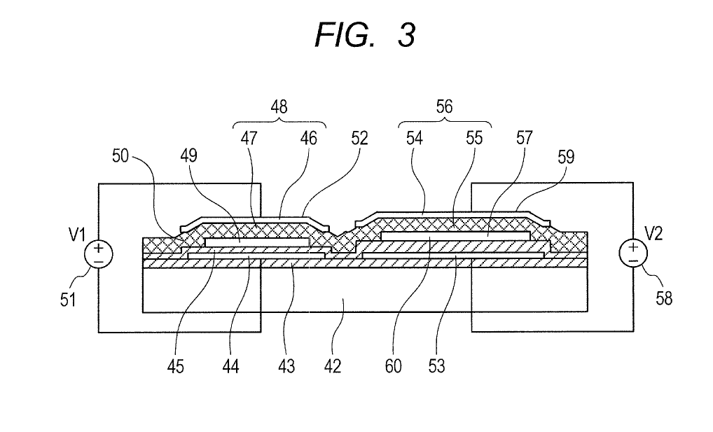

The structure of a capacitive transducer according to Example 3 of the present invention is described with reference to FIG. 3. The structure of the capacitive transducer according to Example 3 is substantially the same as in Example 1.FIG. 3 is a view corresponding to the cross-sectional view taken along the line A-B of FIG. 1A. In FIG. 3, portions corresponding to the respective portions of FIGS. 1A and 1B are given the numbers of the respective portions of FIGS. 1A and 1B plus 40.

In Example 3, a first cell 52 and a second cell 59 each have a cavity height of 100 nm. An insulating film 60 of the second cell 59 has a thickness of 400 nm. The capacitive transducer further includes a voltage applying unit 51 for applying a voltage to the first cell 52 and a voltage applying unit 58 for applying a voltage to the second cell 59. In other words, in Example 3, an inter-electrode distance in the second cell 59 that includes a vibrating film 56 having a small spring constant is set to be larger than an inter-electrode distance in the first cell 52 by increasing the thickness of the insulating film 60. The thickness of the insulating film 60 of the second cell 59 is 400 nm, and hence the pull-in voltage of the second cell 59 can be set to 140 V. The pull-in voltage of the first cell 52 is 200 V, and hence there is a small difference between the pull-in voltage of the first cell and the pull-in voltage of the second cell.

The voltage applying unit 51 can be used to apply a voltage of 160 V, which is 80% of the pull-in voltage of the first cell 52, and the voltage applying unit 58 can be used to apply a voltage of 112 V, which is 80% of the pull-in voltage of the second cell 59. The voltages can be applied to the first cell and the second cell at the same ratio to the pull-in voltages.

Therefore, in the capacitive transducer according to Example 3, the receiving frequency band width or the transmitting frequency band width can be increased, and the transmitting sensitivity or the receiving sensitivity can be improved. As described above, even when the same pull-in voltage cannot be set in the first and second cells, by providing separate voltage applying units for the first and second cells, the voltages to be applied to the cells can be adjusted to have the same ratio to the respective pull-in voltages in the cells.

### Example 4

A probe including the capacitive transducer described in the above-mentioned embodiment or examples is applicable to a test object information acquiring device using acoustic waves. An acoustic wave from a test object is received by the capacitive transducer, and an output electric signal is used to acquire test object information that reflects an optical property value of the test object, such as a light absorption coefficient.

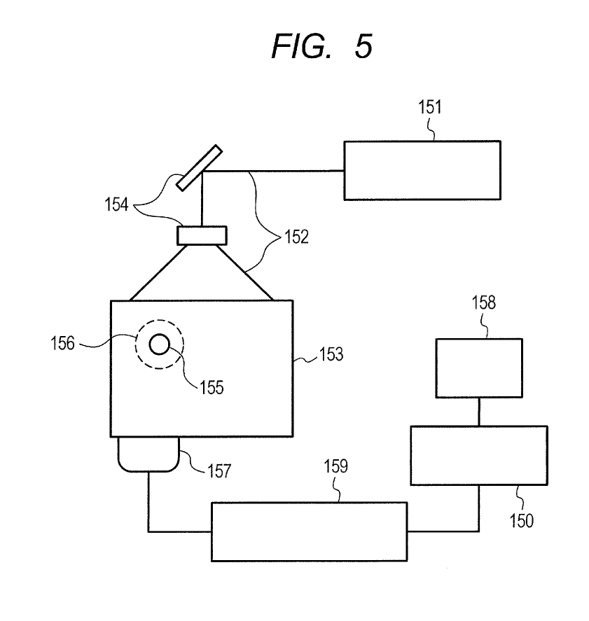

FIG. 5 illustrates a test object information acquiring device of Example 4 using a photoacoustic effect. Pulsed light 152 emitted from a light source 151 for generating light in the form of a pulse irradiates a test object 153 via an optical member 154 such as a lens, a mirror, or an optical fiber. A light absorber 155 inside the test object 153 absorbs energy of the pulsed light to generate a photoacoustic wave 156 as an acoustic wave. A probe 157, which is equipped with a casing that accommodates the capacitive transducer having broadband characteristics of the present invention, receives the photoacoustic wave 156 to convert the photoacoustic wave 156 into an electric signal, and outputs the electric signal to a signal processor 159. The signal processor 159 subjects the input electric signal to signal processing such as A/D conversion and amplification, and outputs the resultant signal to a data processor 150. The data processor 150 uses the input signal to acquire test object information (test object information that reflects an optical property value of the test object, such as a light absorption coefficient) as image data. A display unit 158 displays an image based on the image data input from the data processor 150. The probe may be configured to scan mechanically or may be configured to be moved by a user, such as a doctor or an engineer, relative to the test object (handheld type). It should be understood that the capacitive transducer as an electromechanical transducer of the present invention can be used also in a test object diagnosis apparatus for detecting an acoustic wave from a test object irradiated with the acoustic wave. Also in this case, the acoustic wave from the test object is detected by the capacitive transducer, and a converted signal is processed by the signal processor, to thereby acquire information inside the test object. In this case, the capacitive transducer of the present invention can be used to transmit an acoustic wave toward the test object.

The capacitive transducer according to the present invention is applicable to an optical imaging device for acquiring information in a measurement target such as a living body, a conventional ultrasonic diagnosis apparatus, or the like. The capacitive transducer according to the present invention is applicable also to other applications including a supersonic detector.

The capacitive transducer according to the present invention includes multiple kinds of cells having different spring constants of the vibrating films and different inter-electrode distances. As a result, the capacitive transducer that includes multiple kinds of cells having different frequency characteristics of receiving sensitivity or transmitting sensitivity and therefore has a wide receiving frequency band width or transmitting frequency band width can be realized by flexible design within the above-mentioned structural restrictions.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

### REFERENCE SIGNS LIST

1 capacitive transducer
4, 13 first electrode
6, 14 second electrode
7, 15 membrane
8, 16 vibrating film
9, 17 cavity (gap)
10 supporting portion
11 voltage applying unit
12 first cell
19 second cell

What is claimed is:

1. A capacitive transducer comprising an element comprising a plurality of cells,
each of the plurality of cells comprising:
a first electrode;
a vibrating film comprising a second electrode, the second electrode being opposed to the first electrode with a gap; and
a supporting portion that supports the vibrating film so as to form the gap,
wherein the element comprises a first cell and a second cell as the cell, the first cell comprising the vibrating film having a first spring constant, the second cell comprising the vibrating film having a second spring constant smaller than the first spring constant, and
wherein a distance between the first electrode and the second electrode of the first cell is smaller than a distance between the first electrode and the second electrode of the second cell.

2. The capacitive transducer according to claim 1, wherein the vibrating film of the first cell has a thickness larger than a thickness of the vibrating film of the second cell, and the vibrating film of the first cell has an area equal to an area of the vibrating film of the second cell.

3. The capacitive transducer according to claim 1, wherein the vibrating film of the first cell has an area smaller than an area of the vibrating film of the second cell, and the vibrating film of the first cell has a thickness equal to a thickness of the vibrating film of the second cell.

4. A test object information acquiring device, comprising:
the capacitive transducer according to claim 1;
a voltage applying unit configured to apply a voltage between the first electrode and the second electrode; and
a signal processor configured to process a signal output from the capacitive transducer,
wherein the capacitive transducer is configured to receive an acoustic wave, and the signal processor is configured to process a signal obtained by conversion into an electric signal, to thereby acquire information on the test object.

5. The capacitive transducer according to claim 1, further comprising a light source configured to emit light, wherein the capacitive transducer is configured to receive an acoustic wave generated by the light that has been emitted from the light source to irradiate a test object, and the signal processor is configured to process a signal obtained by conversion into an electric signal, to thereby acquire information on the test object.

6. A method of manufacturing the capacitive transducer according to claim 1, the method comprising:
forming a first electrode of each of multiple kinds of the cells;
forming a sacrificial layer on the first electrode in order to form a gap of the each of the multiple kinds of the cells;
forming, on the sacrificial layer, at least a part of a vibrating film of the each of the multiple kinds of the cells; and
removing the sacrificial layer,
wherein the forming a sacrificial layer comprises varying a thickness of the sacrificial layer that forms the gap of the each of the multiple kinds of the cells.
